(19) United States
(12) Patent Application Publication
(10) Pub. No.: US 2002/0161663 A1
(43) Pub. Date: Oct. 31, 2002

(54) Method for providing cyber fair through computer network system and medium for recording the same

(76) Inventors: Sang-Hyun Kang, DaeHwa-Dong (KR); Young-Soo Kim, Cheong dam-Dong (KR)

Correspondence Address: YOUNG & THOMPSON, 745 SOUTH 23RD STREET 2ND FLOOR, ARLINGTON, VA, 22202

(21) Appl. No.: 09/979,135

(22) PCT Filed: Mar. 16, 2001
(86) PCT No.: PCT/KR01/00424

(30) Foreign Application Priority Data
Mar. 17, 2000 (KR) 200013645
Nov. 22, 2000 (KR) 200069484

(51) Int. Cl. G06F 17/60

(52) U.S. Cl. 705/26

(57) ABSTRACT

A method for providing a cyber fair through a computer network system which includes a server computer and a plurality of user computers connected to the server computer via a network. This method comprises the step of inputting and storing entries for specialized exhibitions to be held for specific goods for a predetermined period of time and standing exhibitions held for a variety of products for the period in which each exhibition is held, and information to be presented by companies participating in each exhibition (S8), processing the stored information and holding each exhibition according to the result of processing (S10), opening communication rooms to enable real-time events, conversation and seminars to be made between visitors and the participating companies in each exhibition being held (S13), and allowing visitors to make purchase orders for the products they desire to buy, and thereafter, the relevant companies to determine whether to accept the orders.

### TECHNICAL FIELD

The present invention relates in general to a method for providing a cyber fair through a computer network system and a medium for recording the same, and more particularly, to a method for providing a cyber fair through a computer network system which includes a server computer for providing the cyber fair and a plurality of user computers connected to the server computer via a network, and a medium for recording the same.

1. Background Art

Cyber markets provided by server computers are currently popular in computer network systems, for example, Internet systems. However, most of the cyber markets have failed to provide the customers with information about a variety of products and providers thereof in an organized and effective manner, and only the services for auction are currently operated in the cyber markets. But, there are many cases that a customer is invited to buy an unwanted product on impulse; or otherwise, much time and effort is requested to buy a desired product.

2. Disclosure of the Invention

Therefore, the present invention has been made in view of the above-described problems, and it is an object of the present invention to provide a method for providing a cyber fair through a computer network system so as to provide the customers with information regarding a variety of products and their respective providers in an organized and effective manner, to thereby allow the very product desired by a purchaser to be easily and reliably traded, and a medium for recording the same.

In accordance with one aspect of the present invention, the above and other objects can be accomplished by the provision of a method for providing a cyber fair through a computer network system which includes a server computer for providing the cyber fair and a plurality of user computers connected to the server computer via a network, comprising the steps of a) inputting and storing entries for specialized exhibitions to be held for specific goods for a predetermined period of time and standing exhibitions held for a variety of products for the period in which each exhibition is held, and information to be presented by companies participating in each exhibition; b) processing the information stored at said step a) and holding each exhibition according to the result of processing; c) opening communication rooms to enable real-time events, conversation and seminars to be made between visitors and the participating companies in each exhibition being held; and d) allowing visitors to make purchase orders for the products they desire to buy, and thereafter, the relevant companies to determine whether to accept the orders.

Preferably, an exhibition may be held based on the information stored in the server computer, and a communication room and a trade room corresponding to the exhibition being held may be opened. Therefore, information regarding a variety of products and providers thereof is provided to the customers in an organized and efficient manner, allowing those products which the purchasers desire to buy to be easily and reliably traded.

In accordance with another aspect of the present invention, there is provided a storage medium for recording a method of providing a cyber fair through a computer network system which includes a server computer for providing the cyber fair and a plurality of user computers connected to the server computer via a network.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing the configuration of a computer network system for execution of a method according to the present invention;

FIG. 2 is a flow chart showing a process wherein a cyber fair is provided by a server computer in the computer network system of FIG. 1;

FIG. 3 is a flow chart showing a process wherein a routine for opening a communication room is executed in the process of FIG. 2;

FIG. 4 is a flow chart showing a process wherein a routine for opening a conference room is executed in the process of FIG. 3;

FIG. 5 is a flow chart showing a process wherein a routine for opening a company conference room is executed in the process of FIG. 4;

FIG. 6 is a flow chart showing a process wherein a routine for opening a seminar room is executed in the process of FIG. 3;

FIG. 7 is a flow chart showing a process wherein a routine for opening a private seminar room is executed in the process of FIG. 6; and

FIG. 8 is a flow chart showing a process wherein a routine for opening a trade room is executed in the process of FIG. 2.

### BEST MODE FOR CARRYING OUT THE INVENTION

Hereinbelow, the present invention will be described in detail with reference to the accompanying drawings.

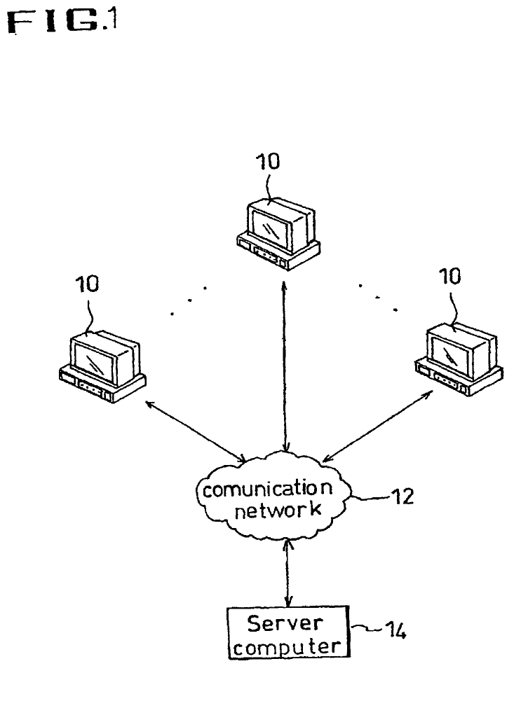

Referring to FIG. 1, there is schematically shown the configuration of a computer network system for execution of a method for providing a cyber fair according to the present invention. As shown in this drawing, a server computer 14 is installed in a company providing a cyber fair according to the present invention. A plurality of user computers 10 gain access to the server computer 14 via a communication network 12, receive images of cyber markets, which the users desire to use, from the computer 14 and then display the received images thereon. The user computers 10 communicate with the server computer 14 by means of an Internet browser program.

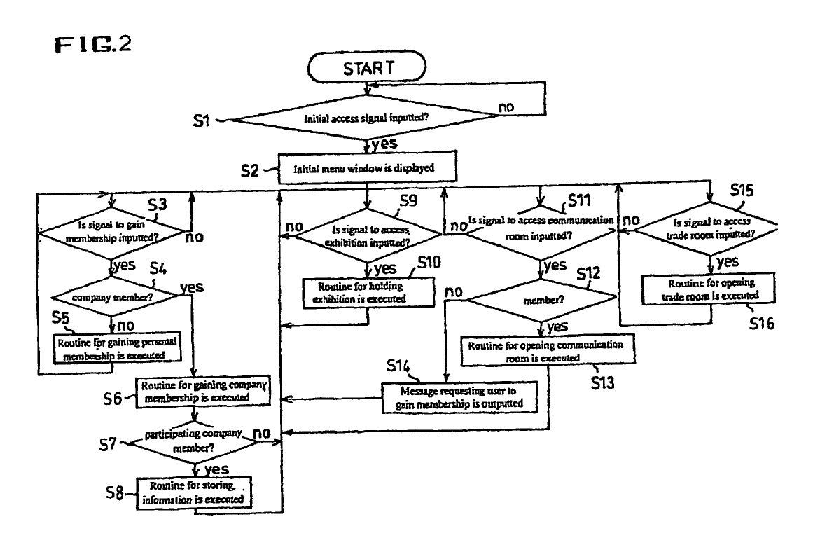

Referring to FIG. 2, which is a flow chart showing a process wherein a cyber market is provided by a server computer 14 in the computer network system of FIG. 1, a method for providing a cyber market according to the present invention comprises a routine for storing information (S8); a routine for holding an exhibition (S10); a routine for opening a communication room (S13) and a routine for opening a trade room (S16).

In the routine for storing information (S8), entries for specialized exhibitions to be held for specific goods for a predetermined period of time and standing exhibitions held for a variety of products for the period in which each exhibition is held, and information to be presented by the company participating in each exhibition are inputted and stored. In the routine for holding an exhibition (S10), the information stored through the routine of the step S8 is processed and each exhibition is held according to the result of processing. In the routine for opening a communication room (S13), the communication room is opened, enabling real-time events, conversation and seminars to be held between visitors and the participating company in each exhibition being held. In the routine for opening a trade room (S16), visitors can make a purchase order for the product they desire to buy, and thereafter, the relevant company determines whether to accept the order, if any.

A process wherein the server computer 14 of the computer network system shown in FIG. 1 executes the method for providing a cyber fair according to the present invention will be described in detail with reference to FIG. 2.

If a signal for an initial access to the server computer 14 is inputted from a user computer 10 of FIG. 1 (S1), the computer 14 displays an initial menu window (S2).

If a signal to gain membership is inputted from the user computer 10 in access to the server computer 14 (S3), the computer 14 determines whether to register the user as a company member (S4). Where the user intends to gain a personal membership rather than a company membership, the computer 14 executes a routine for registering the user as a personal member and confirms that the user is registered as a personal member (S5). Where the user intends to gain a company membership, the computer 14 executes a routine for registering the user as a company member and confirms that the user is registered as a company member (S6). After registration of the company member is confirmed, the computer 14 confirms whether to register the company member as a participating company of an exhibition (S7). Where the company member applies for registration as a participating company of an exhibition, the computer 14 executes the routine of the step S8. In the routine of the step S8, entries for exhibitions specialized in specific products for a predetermined period of time, e.g., for one month, and standing exhibitions for a variety of products for the period in which each exhibition is held, e.g., for one month, for three months, for six months, for one year, etc., and information of the participating companies to be presented to each exhibition are inputted and stored. Where the routine in the step S8 is directly executed in the initial menu window, the registered participating company automatically gains a company membership without passing the routine for gaining the company membership (S6).

While the routine in the step S8 is being executed, information introducing each participating company, its desired exhibition room, products to be exhibited, any events held with the exhibition, and their promotion means is inputted and stored. The information introducing each participating company is inputted and stored in combined forms of moving pictures and narration, moving pictures and text, graphics and text, and photos and text, or in the form of text alone. Display information on the exhibition room is inputted and stored in three-dimensional graphics. The product information is inputted and stored in moving pictures, photos or combined narration and text. The event information, which is relevant to product advertisements, promotional events, etc., is inputted and stored. The promotion means information, which is relevant to technical means for promotion, is inputted and stored.

If a signal to access an exhibition is inputted from an accessed user computer 10 (S9), a routine for holding an exhibition is executed (S10). In the routine of the step S10, information stored through the step S8 is processed and each relevant exhibition is held. A program for executing the routine for holding an exhibition (S10) is recorded in WRML (Virtual Reality Modeling Language), one of three-dimensional modeling languages. The WRML is a programming language for materializing a virtual reality on the Internet using a Web browser. Accordingly, the user can feel as if his virtual character (called “avatar”) moves in the real exhibition, by manipulating the mouse of the user computer 10. The product to be displayed is displayed identically with the actual product in an off-line exhibition, and the displayed product can be enlarged in size and turned in direction by the user computer 10.

If a signal to access a communication room is inputted from an accessed user computer 10 (S11), the server computer 14 confirms whether the user inputting the signal is registered or not (S12). If the user is registered, a routine for opening a communication room is executed (S13). Otherwise, if the user is not registered, a message requesting the user to gain membership is outputted S14). The reason for which only the registered users are allowed to access the communication room is because it is necessary to control the attendees in respect of the communication room itself for business. In the routine of the step S13, a communication room is opened so that events, conversation and seminars can be performed between visitors and the participating company of each exhibition held.

If a signal to access a trade room is inputted from an accessed user computer 10 (S15), a routine for opening a trade room is executed (S16). Following the routine of the step S16, in the opened trade room, a visitor of each exhibition being held orders the product he desires to buy and the relevant participating company accepts the order.

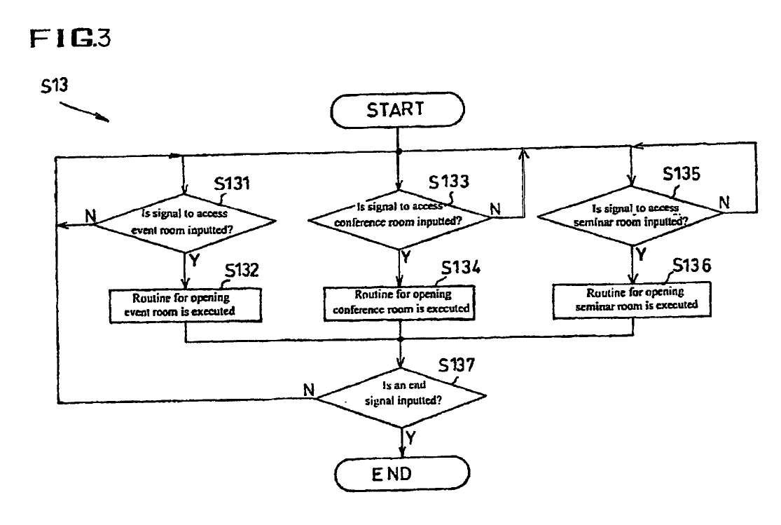

Referring to FIG. 3, the routine for opening a communication room (S13) of FIG. 2 includes a routine for opening an event room (S132), a routine for opening a conference room (S134) and a routine for opening a seminar room (S136). A process through which the routine for opening a communication room (S13) is executed will be described with reference to FIG. 3.

If a signal to access an event room is inputted (S131), a routine for opening an event room is executed (S132). In the routine of the step S132, promotional events held by a participating company are executed. If a signal to access a conference room is inputted (S133), a routine for opening a conference room is executed (S134). In the routine of the step S134, company members including the participating company are allowed to open their respective conference rooms, and therefore, one to one or one to multiple consultations are available between the company opening the conference room and the other company members. Thus, it is advantageous to the participating company in that it can enter the conference room being opened and perform promotional activities therein.

If a signal to access a seminar room is inputted (S135), a routine for opening a seminar room is executed (S136). In the routine of the step S135, communications between the computer 10 (see FIG. 1) of each participating company and the computers 10 (see FIG. 1) of the participants entering the seminar room are available in the seminar room.

A process in which a seminar is proceeded will be described as follows: A participating company opening a seminar room transmits lecture data (in moving pictures and narration) on the products made by a product expert of the company to the server computer 14 (see FIG. 1) in real time. The lecture data transmitted to the computer 14 is transmitted to each participant's computer accessing the seminar room in real time, so that the participants can view and hear the lecture. If the lecture finishes and the participant has any questions, the participant transmits the question data (in moving pictures, narration or text) to the seminar room. The question data received in the seminar room is sequentially transmitted to the computer of the company opening the seminar room. The lecturer of the seminar transmits a response to the received question to the participant's computer in real time through the seminar room. In order to facilitate this process, a moderator may be added so as to arrange a number of questions and responses thereto and proceeding the seminar.

The routine of the step S13 is terminated if an end signal is inputted from the user computer 10 (S137) during its execution.

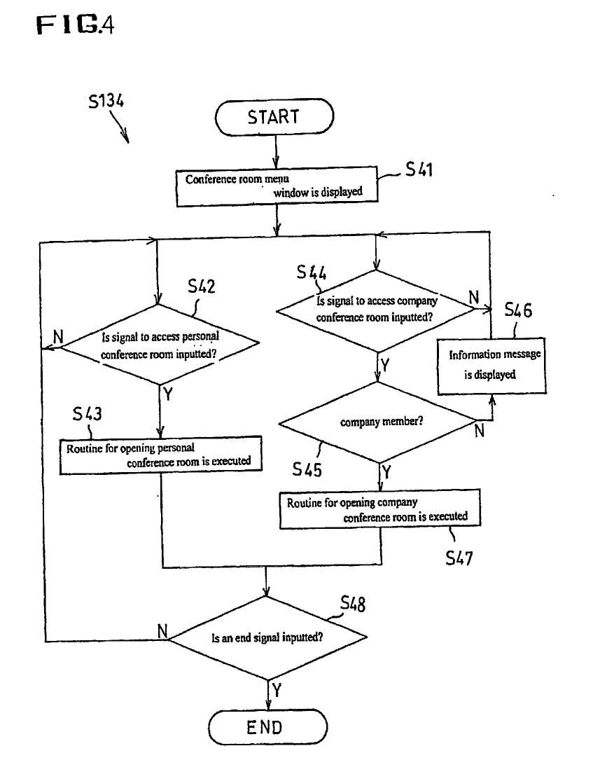

A process in which a routine for opening a conference room (S134) of FIG. 3 is executed will be described with reference to FIG. 4.

A menu window for a conference room is outputted (S41). In the conference room menu window there are displayed a button for accessing a personal conference room and a button for accessing a company conference room. If a signal to access the personal conference room is inputted from a user computer 10 in response to a user's pushing the button for personal conference room access (S42), a routine for opening a personal conference room is executed (S43). If a signal to access the company conference room is inputted from a user computer 10 in response to a user's pushing the button for company conference room access (S44), it is confirmed whether the accessed user is a company member (S45). If it is confirmed that the user is not a company member, a message indicating that only company members can enter the company conference room is displayed (S46). If the user is a company member, a routine for opening a company conference room is executed (S47).

The routine of the step S134 is terminated if an end signal is inputted from the user computer 10 (S48) during its execution.

As described above, since the routine for opening a conference room (S134) is divided into a routine for opening a personal conference room (S43) and a routine for opening a company conference room (S47), a more efficient business conference can be carried out.

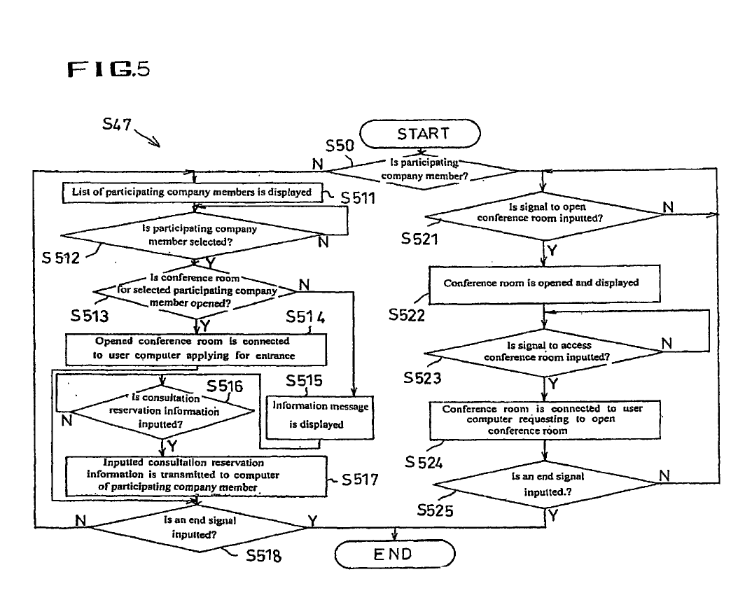

A process in which a routine for opening a company conference room (S47) of FIG. 4 is executed will be described with reference to FIG. 5. The same algorithm as the routine of the step S43 will be used in routine of the step S47.

First, it is confirmed whether the accessed company member is a company member which participates in an exhibition (S50).

If it is confirmed that the accessed company member is not a company member participating in an exhibition, the accessed company member is regarded as a company member which will participate as a consultant, and thus, the steps S511 through S518 to be described later are performed. In the step S511, a list of company members participating in the exhibition is displayed. If a participating company member is selected by an accessed user (S512), it is then confirmed whether a conference room of the selected participating company member is opened or not (S513). If the conference room is opened by the selected participating company member, the opened conference room accesses a computer of a member who requests consultation (S514). Accordingly, a real time consultation can be performed between the participating company member and the company member requesting consultation. The above-described processes are repeated until an end signal is inputted (S518).

If it is confirmed that an accessed company member is a company member participating in an exhibition (S50), the accessed member is regarded as a participating company member, and therefore, the steps S521 through S525 to be described later are performed. In the step S521, it is confirmed whether a signal to open a conference room is inputted from the accessed participating company member's computer 10. If this signal is inputted, the conference room is opened and displayed (S522). Then, it is confirmed whether a signal to access a conference room is inputted from the computer 10 of a company member who applies for consultation (S523). If this signal is inputted, the computer 10 of the member applying for the access thereto is allowed to access the opened conference room (S524). Accordingly, a real time consultation can be performed between the participating company member and the company member who applied for consultation. The above-described processes are repeated until an end signal is inputted (S525).

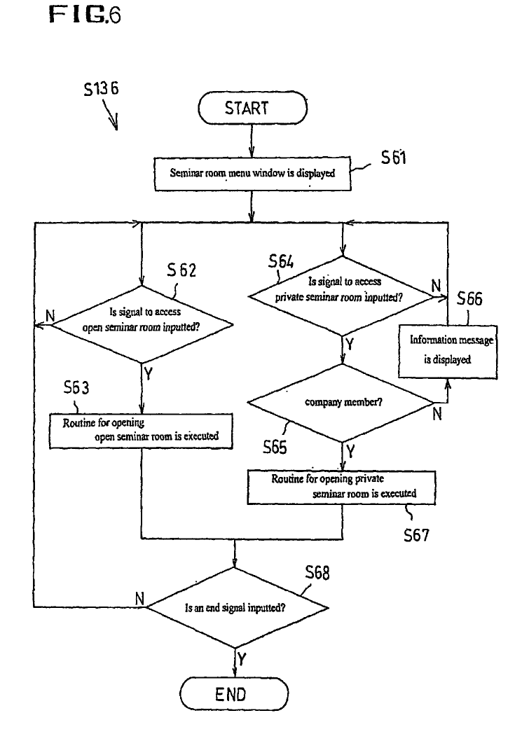

A process in which a routine for opening a seminar room (S136) of FIG. 3 is executed will be described with reference to FIG. 6.

First, a menu window for a seminar room is outputted (S61). In the seminar room menu window there are displayed a button for accessing an open seminar room and a button for accessing a private seminar room. If a signal to access the open seminar room is inputted from a user computer 10 in response to a user's pushing the button for open seminar room access (S62), a routine for opening an open seminar room is executed (S63). If a signal to access the private seminar room is inputted from a user computer 10 in response to a user's pushing the button for private seminar room access (S64), it is confirmed whether the accessed user is a company member (S65). If it is confirmed that the user is not a company member, a message indicating that only company members can enter the company conference room is displayed (S66). If the user is a company member, a routine for opening a private seminar room is executed (S67). The routine of the step S136 is terminated if an end signal is inputted from the user computer 10 (S68) during its execution.

As described above, since the routine for opening a seminar room (S136) is divided into a routine for opening an open seminar room (S63) and a routine for opening a private seminar room (S67), a more efficient business conference can be carried out.

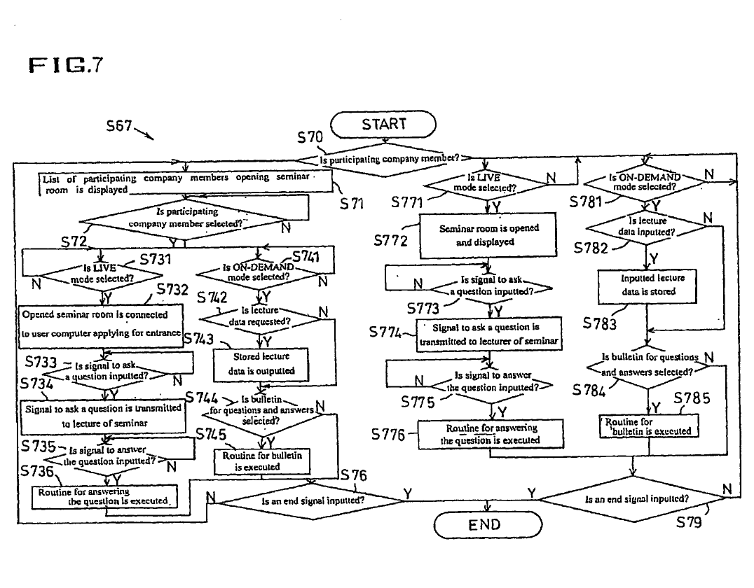

A process in which a routine for opening a private seminar room (S67) of FIG. 6 is executed will be described with reference to FIG. 7. The same algorithm as the routine of the step S63 for opening an open seminar room (see FIG. 6) will be used in the routine of the step S67.

First, it is confirmed whether the accessed company member is a company member which participates in an exhibition (S70).

If it is confirmed that the accessed company member is not a company member participating in an exhibition, the accessed company member is regarded as a company member which will attend a seminar room, and thus, a routine with respect to an attendee (in the left part of FIG. 6) is executed.

In the step S71, a list of company members opening private seminar rooms is displayed. Here, it is available for only a list of the participating company members whose seminar rooms are reserved by the accessed company member for attending them to be displayed. If a participating company member is selected by an accessed company member (S72), either a LIVE mode (S731 through S736) or an ON-DEMAND mode (S741 through S745) is executed at the accessed company member's option. As described above, since the attendee routine (in the left part of FIG. 7) is divided into the LIVE mode (S731 through S736) and the ON-DEMAND mode (S741 through S745), a more efficient seminar can be performed.

With respect to the LIVE mode (S731 through S736) of the attendant routine (in the left part of FIG. 7), if the LIVE mode is selected by the accessed company member (S731), the computer 10 of the company member applying to attend the seminar room (S732) gains access to the opened seminar room. Accordingly, the company member applying for attendance can attend the room of the seminar in real time. Then, if a signal to ask a question is inputted from the user computer 10 (S733), the inputted question signal is transmitted to the lecturer of the seminar (S734). Accordingly, the lecturer of the seminar room receives the question asked through Internet phones or e-mails, etc. and can input a signal to indicate that the answer is available, if the answer is instantly available (S735). If this signal is inputted from the computer 10 of the lecturer of the seminar room, the question and the answer are exchanged between the questioner and the lecturer (S736). The above-described steps are repeated until an end signal is inputted (S76).

With respect to the ON-DEMAND mode (S741 through S745) of the attendant routine (in the left part of FIG. 7), if the ON-DEMAND mode is selected by the accessed company member, that is, a member participating in the seminar, it is confirmed whether a signal to request the published materials is inputted from the computer 10 of the participating company member (S742). If the signal to request the published materials is inputted, the published materials stored in the database of the server computer 14 are outputted (S743). Otherwise, it is confirmed whether a bulletin for questions and answers is selected (S744). If the bulletin is selected, a routine with respect to the bulletin is executed (S745). Accordingly, the participating member can ask a question related to the lecture at the seminar and receive an answer thereto, through a question and answer bulletin. The above-described steps are repeated until an end signal is inputted (S76).

If it is confirmed that the accessed company member is a company member participating in an exhibition in the step S70, the accessed member is regarded as a participating company member opening a seminar room, and therefore, a routine with respect to sponsor holding the seminar (in the right part of FIG. 7) is executed. Either a LIVE mode (S771 through S776) or an ON-DEMAND mode (S781 through S785) is executed at the accessed company member's option, that is, at the option of the company member holding the seminar. As described above, since the sponsor routine (in the right part of FIG. 7) is divided into the LIVE mode (S771 through S776) or the ON-DEMAND mode (S781 through S785), a more efficient seminar can be performed.

With respect to the LIVE mode (S771 through S776) of the sponsor routine (in the right part of FIG. 7), if the LIVE mode is selected by the accessed company member (S771), a seminar room is opened and the opened seminar room is displayed (S772). Accordingly, the sponsor can hold the seminar in an on-line seminar room as if he does in an off-line seminar room, with moving pictures. Then, if a signal to ask a question is inputted from the user computer 10 (S773), the inputted question signal is transmitted to the lecturer of the seminar (S774). Accordingly, the lecturer of the seminar room ascertains the question asked through Internet phones or e-mails, etc. and can input a signal indicating that the answer is available, if the answer is instantly available (S775). If this signal is inputted from the computer 10 of the lecturer at the seminar room, the question and the answer are exchanged between the questioner and the lecturer (S776). The above-described steps are repeated until an end signal is inputted (S79).

With respect to the ON-DEMAND mode (S781 through S785) of the sponsor routine (in the right part of FIG. 7), if the ON-DEMAND mode is selected by the accessed company member, that is, a member participating in the seminar, it is confirmed whether a signal to request the published materials is inputted from the computer 10 of the participating member (S782). If the signal to request the published materials is inputted, the published materials stored in the database of the server computer 14 are outputted (S783). Otherwise, it is confirmed whether a bulletin for questions and answers is selected (S784). If the bulletin is selected, a routine with respect to the bulletin is executed (S785). Accordingly, the participating member can ask questions related to the subject of the seminar and receive answers thereto, through a question and answer bulletin. The above-described steps are repeated until an end signal is inputted (S79).

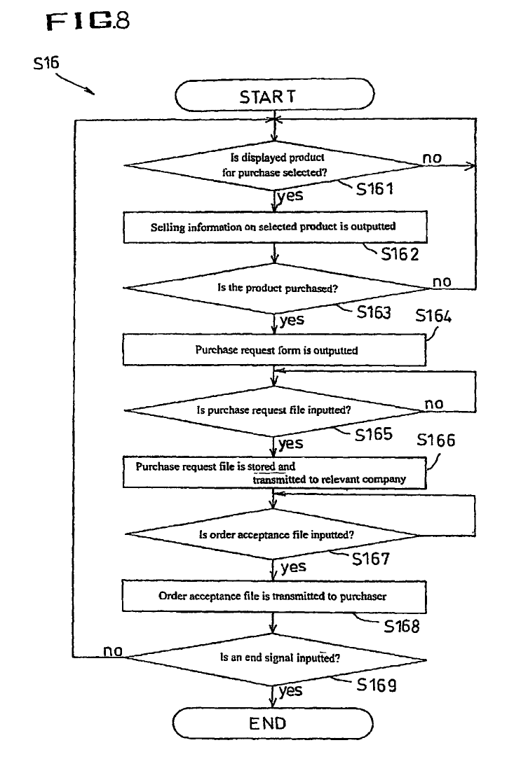

Lastly, a process in which a routine for opening a trade room (S16) of FIG. 2 is executed will be described with reference to FIG. 8.

If a product displayed in an exhibition is selected for purchase (S161), selling information regarding the selected product is outputted (S162). Accordingly, the visitor selecting the displayed product to buy can view detailed information regarding the relevant product in his computer 10 (see FIG. 1), and determine whether to buy it. Then, a signal to confirm purchase of the selected product is inputted from the visitor (S163), a specified form for purchase order is outputted (S164). Thus, the person applying for purchase, that is, the purchaser, prepares a purchaser order file according to the outputted purchase order form and transmits it to the server computer 14. If the purchaser order file is inputted (S165), the computer 14 stores the inputted purchase order file in the database and transmits it to the relevant participating company, that is, the computer 10 of the selling company (S166). Accordingly, the selling company can determine whether to accept the purchase order as a result of reviewing the inputted purchase order file. If it is determined to accept the purchase order, the selling company prepares an order acceptance file and transmits it to the server computer 14. If the order acceptance file is inputted from the computer of the selling company, the server computer 14 transmits it to the purchaser's computer 10.

The method for providing a cyber fair according to the present invention as described above is stored in a medium whose contents contained therein are readable by the server computer. The storage medium includes all kinds of mediums available for storing programs and data therein, so that they can be read by the computer system. Examples of such mediums include, not limited to, ROM (Read Only Memory), RAM (Random Access Memory), CD-Rom (Compact Disk-Read Only Memory), magnetic tapes, floppy disks, optical data storage means, etc. The medium in the form of carrier waves (for example, transmission via Internet) can be included in that category. The storage mediums are dispersed in the computer system connected by a network, and thus, a code readable by the computer in a disperse manner is stored and executed.

Industrial Applicability

As apparent from the above description, the present invention provides a method for providing a cyber fair wherein an exhibition is held based on the information stored in the server computer, and a communication room and a trade room corresponding to the exhibition being held are opened, and a medium for recording the same. With the processes therefor, information regarding a variety of products and providers thereof is provided to the customers in an organized and efficient manner, allowing those products which the purchasers desire to buy to be easily and reliably traded.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for providing a cyber fair through a computer network system which includes a server computer for providing the cyber fair and a plurality of user computers connected to the server computer via a network, comprising the steps of:
a) inputting and storing entries for specialized exhibitions to be held for specific goods for a predetermined period of time and standing exhibitions held for a variety of products for the period in which each exhibition is held, and information to be presented by companies participating in each exhibition;
b) processing the information stored at said step a) and holding each exhibition according to the result of processing;
c) opening communication rooms to enable real-time events, conversation and seminars to be made between visitors and the participating companies in each exhibition being held; and
d) allowing visitors to make purchase orders for the products they desire to buy, and thereafter, the relevant companies to determine whether to accept the orders.

2. The method according to claim 1, wherein said step a) includes the step of inputting and storing information introducing each participating company, its desired exhibition room, products to be exhibited, any events held with the exhibition, and the promotion means.

3. The method according to claim 1, wherein said step c) includes the steps of:
c-1) holding a participating company of each exhibition to open an event room for conducting a variety of events;
c-2) holding a participating company of each exhibition to open a conference room for a business meeting between the participating company and visitors; and
c-3) holding a participating company of each exhibition to open a seminar room for providing lecture data from the participating company to visitors and exchanging questions and answers between the visitors and the lecturer of the seminar.

4. The method according to claim 3, wherein said step c-3) includes the steps of:
c-3-1) performing a LIVE mode to provide the lecture data from the participating company of each exhibition to the visitors in real time and exchange questions and answers between the visitors and the lecturer of the seminar in real time;
c-3-2) performing an ON-DEMAND mode to provide the lecture data from the lecturer to the visitor at his request and exchange questions and answers therebetween through a separate bulletin; and
c-3-3) selectively performing said LIVE mode and ON-DEMAND mode at the participating company's option or the visitors' option.

5. The method according to claim 1, wherein said step d) includes the steps of:
d-1) outputting selling information regarding a product displayed in an exhibition if it is selected for purchase;
d-2) outputting a specified form for requesting the purchase order if a signal to confirm purchase of the product is inputted;
d-3) storing a purchase order file and transmitting it to a relevant participating company's computer if the purchase order file according to the outputted purchase order form is inputted; and
d-4) transmitting an order acceptance file to the purchaser's computer if it is inputted from the relevant participating company's computer.

6. A storage medium for recording a method of providing a cyber fair through a computer network system which includes a server computer for providing the cyber fair and a plurality of user computers connected to the server computer via a network, said method comprising the steps of:
a) inputting and storing entries for specialized exhibitions to be held for specific goods for a predetermined period of time and standing exhibitions held for a variety of products for the period in which each exhibition is held, and information to be presented by companies participating in each exhibition;
b) processing the information stored at said step a) and holding each exhibition according to the result of processing;
c) opening communication rooms to enable real-time events, conversation and seminars to be made between visitors and the participating companies in each exhibition being held; and
d) allowing visitors to make purchase orders for the products they desire to buy, and thereafter, the relevant companies to determine whether to accept the orders.
